(19) United States
(12) Patent Application Publication
(10) Pub. No.: US 2011/0176035 A1
(43) Pub. Date: Jul. 21, 2011

(54) TILT AND SHIFT ADAPTOR, CAMERA AND IMAGE CORRECTION METHOD

(76) Inventor: Anders Poulsen, Holte (DK)

(21) Appl. No.: 13/000,591

(22) PCT Filed: Jun. 26, 2009
(86) PCT No.: PCT/DK09/00160

§ 371 Date: Apr. 4, 2011

(30) Foreign Application Priority Data
Jun. 27, 2008 (EP) 08011675.9

(51) Int. Cl. H04N 5/217

(52) U.S. Cl. 348/241; 348/E05.078

(57) ABSTRACT

The present invention relates to a device comprising a frame having a first part defining a first plane and a second part defining a second plane. The first part configured to be mounted to a camera body and the second part configured to be mounted to a lens, the second part being movable relative to the first part. Also a sensor configured to detect the position of the second plane relative to the first plane, the sensor configured to transmit position information in electronic form to a processor. Further more the present invention relates to a digital camera including a digital image sensor in a camera housing, an image plane defined in the housing at the digital image sensor, the digital camera further comprising a lens mount for receiving a lens, the lens configured to be movable relative to the housing, and a sensor configured to detect the position of the lens relative to the housing, the sensor configured to transmit position information in electronic form to a processor. Still further the present invention relates to a digital camera including a digital image sensor in a camera housing, the digital image sensor being movably mounted in the camera housing, an image plane defined in the housing by the digital image sensor, the digital camera further comprising a lens mount for receiving a lens, the lens mount fixing the lens to the camera housing, and a sensor configured to detect the position of the digital image sensor relative to the housing, the sensor configured to transmit position information in electronic form to a processor. Even till further the present invention relates to a method of performing correction of digital images comprising the steps of obtaining a digital image using a digital camera having digital image sensor in a camera housing, an image plane defined in the housing at the digital image sensor, the digital camera further comprising a lens, the lens configured to be movable relative to the housing, and a sensor configured to detect the position of the lens relative to the housing, the sensor configured to transmit position information in electronic form to a processor, and performing image correction using position data from the sensor.

The present invention relates to a device for providing tilt and shift of lenses for cameras, cameras having tilt and shift capability for lenses and image sensors and also to a method of performing correction of digital images.

In several situations a photographer needs to take pictures of objects having planes that are not directly in the plane of focus, meaning that the subject plane is not correctly orientated in the image plane. This could for instance be a photograph of a pizza taken in perspective, an aerial photo of a landscape or a high building. These images may suffer from distortion, e.g. in an image of a high building the sides of the building may seem to converge at the top.

One solution to this is based on the so-called Scheimpflug principle. This may involve tilting, shifting and rotation of the lens relative to the image plane.

The above principle has been implemented in view cameras. A view camera comprises a flexible bellows which forms a light-tight seal between two adjustable standards one of which holds a lens, and the other a viewfinder or a photographic film holder. The bellows is a flexible, accordion-pleated box, which encloses the space between the lens and film, and has the ability to flex to accommodate the movements of the standards. The front standard is a board at the front of the camera which holds the lens and, usually, a shutter. At the other end of the bellows, the rear standard is a frame which holds a ground glass, used for focusing and composing the image before exposure, which is replaced by a holder containing the light-sensitive film, plate, or image sensor for exposure. The front and rear standards can move in various ways relative to each other, unlike most other types of camera, giving control over focus, depth of field and perspective.

The photographer taking the picture then positions the camera and manipulates the front end to obtain a focus plane that coincides with the object plane of the object to be photographed. Especially when using this sort of technique in combination with a digital camera there is a need for knowing the position of the lens relative to the image plane in the camera so that the image may be compensated correctly.

This may be achieved by a device according to an aspect of the present invention wherein the device may comprise a frame having a first part defining a first plane and a second part defining a second plane, the first part configured to be mounted to a camera body and the second part configured to be mounted to a lens, the second part being movable relative to the first part, and a sensor configured to transmit a sensor signal to a processor, the position of the second plane relative to the first plane being determined based on the sensor signal, the processor being configured to calculate an image correction parameter based on the position information, the image correction parameter being used for correcting optical errors in a recorded image due to the position of the lens relative to the image plane, the optical errors including vignetting, distortion, aberration or a combination thereof.

The device may be used as an adaptor allowing a lens to be tilted, shifted and/or rotated relative to a camera housing.

Further more, an aspect of the present invention relates to a digital camera including a digital image sensor in a camera housing, an image plane defined in the housing at the digital image sensor, the digital camera further comprising a lens mount for receiving a lens, the lens configured to be movable relative to the housing, and a sensor configured transmit a sensor signal transmit a sensor signal to a processor, the position of the lens relative to the housing being determined based on the sensor signal, the processor being configured to calculate an image correction parameter based on the position information, the image correction parameter being used for correcting optical errors in a recorded image due to the position of the lens relative to the image plane, the optical errors including vignetting, distortion, aberration or a combination thereof.

An aspect of the present invention relates to a digital camera including a digital image sensor in a camera housing, the digital image sensor being movably mounted in the camera housing, an image plane defined in the housing by the digital image sensor, the digital camera further comprising a lens mount for receiving a lens, the lens mount fixing the lens to the camera housing, and a sensor configured transmit a sensor signal transmit a sensor signal to a processor, the position of the digital image sensor relative to the housing being determined based on the sensor signal, the processor being configured to calculate an image correction parameter based on the position information, the image correction parameter being used for correcting optical errors in a recorded image due to the position of the lens relative to the image plane, the optical errors including vignetting, distortion, aberration or a combination thereof.

An aspect of the present invention relates to a digital camera including a digital image sensor in a camera housing, an image plane defined in the housing at the digital image sensor, the digital camera further comprising a lens mount for receiving a lens, the lens configured to be movable relative to the housing, and a sensor configured transmit a sensor signal to a processor, the position of the lens relative to the housing being determined based on the sensor signal, a correction parameter calculated based on the sensor signal, the correction parameter being used for correcting focal settings while the lens is moved relative to the image plane.

An aspect of the present invention relates to a method of performing correction of digital images comprising the steps of obtaining a digital image using a digital camera having digital image sensor in a camera housing, an image plane defined in the housing at the digital image sensor, the digital camera further comprising a lens, the lens configured to be movable relative to the housing, and a sensor configured to detect the position of the lens relative to the housing, the sensor configured to transmit position information in electronic form to a processor, and performing image correction using position data from the sensor.

The present invention will now be discussed in more detail with reference to the appended figures in which:

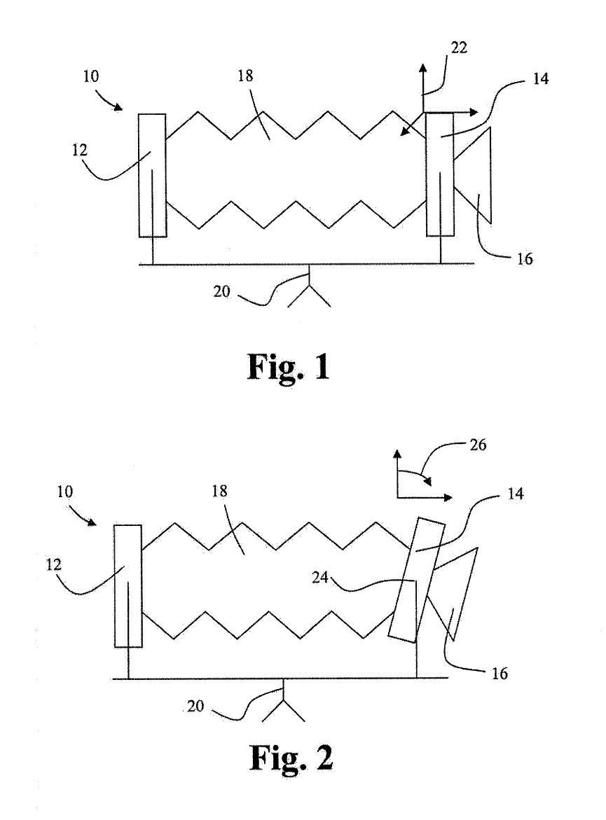

FIG. 1 is a schematic illustration of a view camera,

FIG. 2 is a schematic illustration of the view camera in a first position,

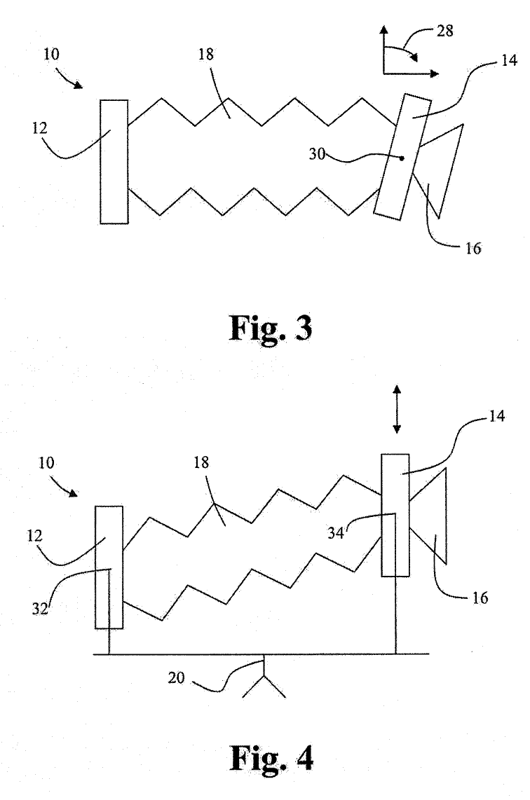

FIG. 3 is a schematic illustration of the view camera in a second position,

FIG. 4 is a schematic illustration of the view camera in a third position,

FIG. 5 is a schematic illustration of the Scheimpflug principle,

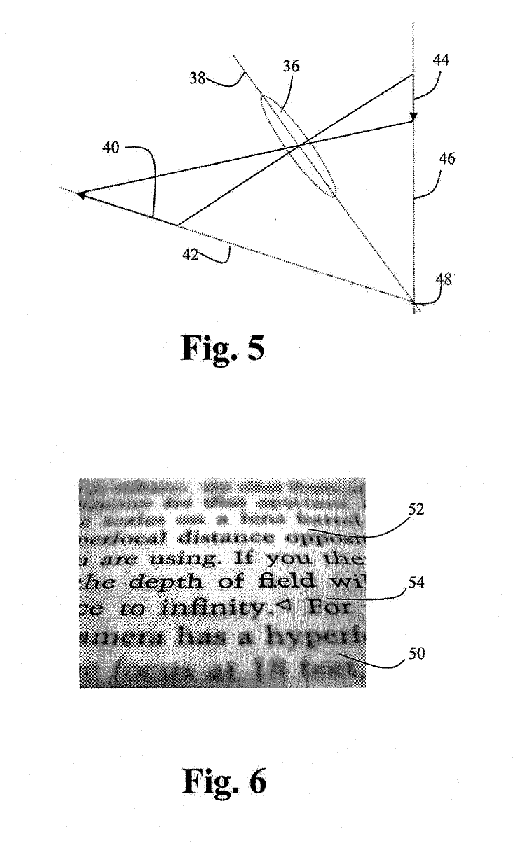

FIG. 6 is an image illustrating focus problems,

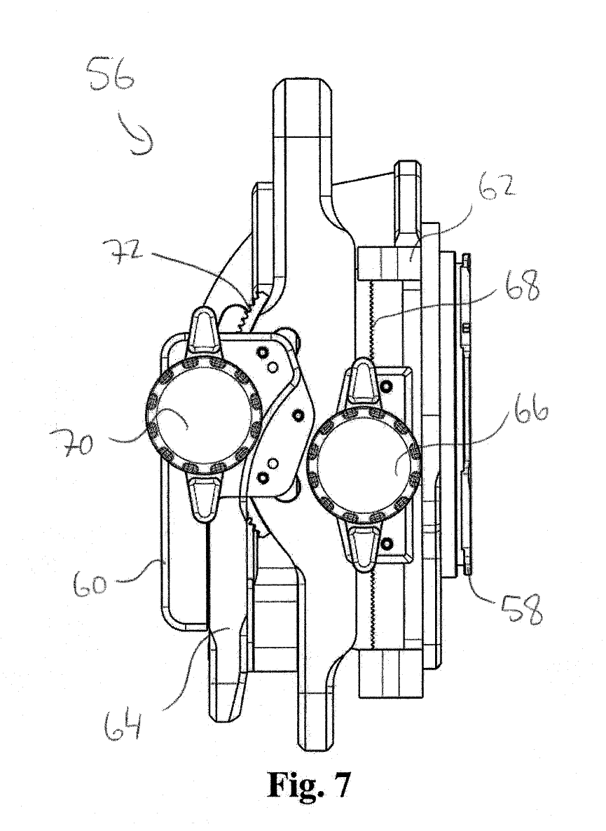

FIGS. 7-9 are schematic illustration of an adaptor according to the present invention,

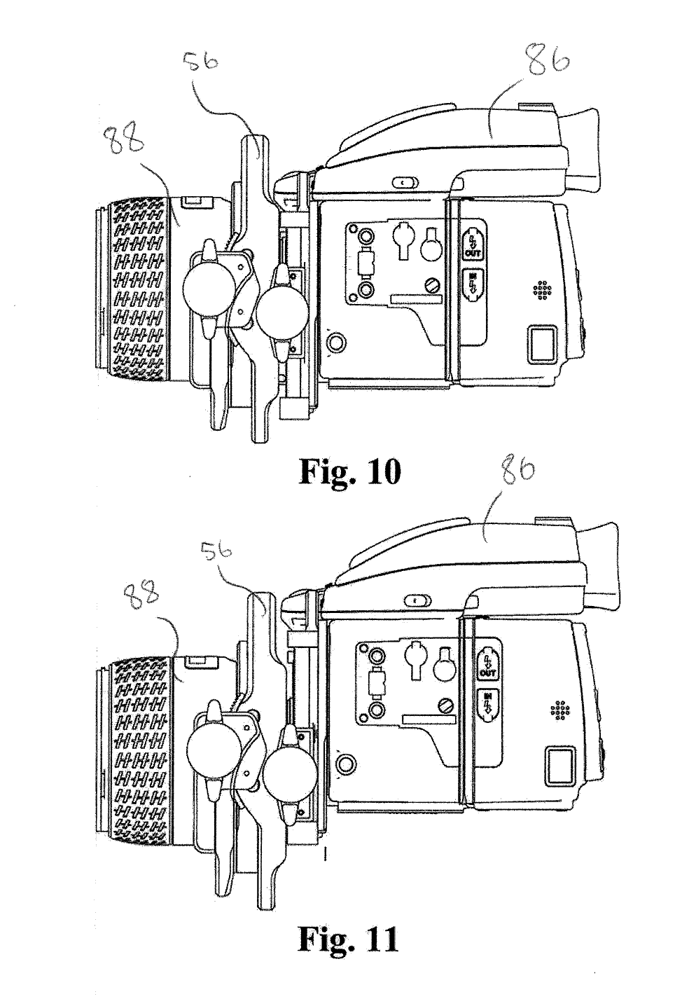

FIGS. 10-13 are schematic illustrations of a camera, a lens and an adaptor according to the present invention,

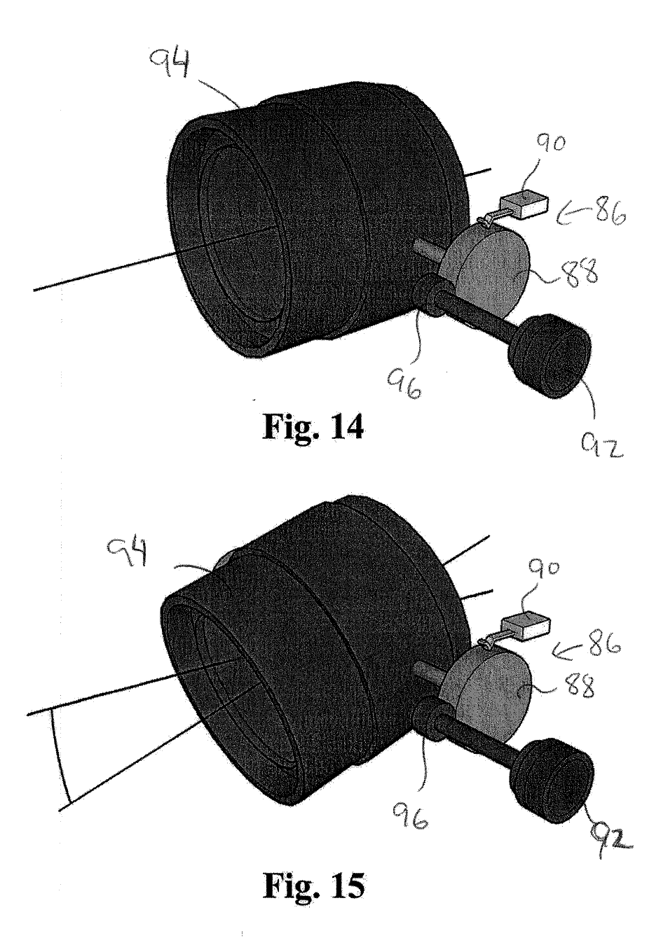

FIGS. 14 and 15 are schematic illustrations illustrating a sensor, and

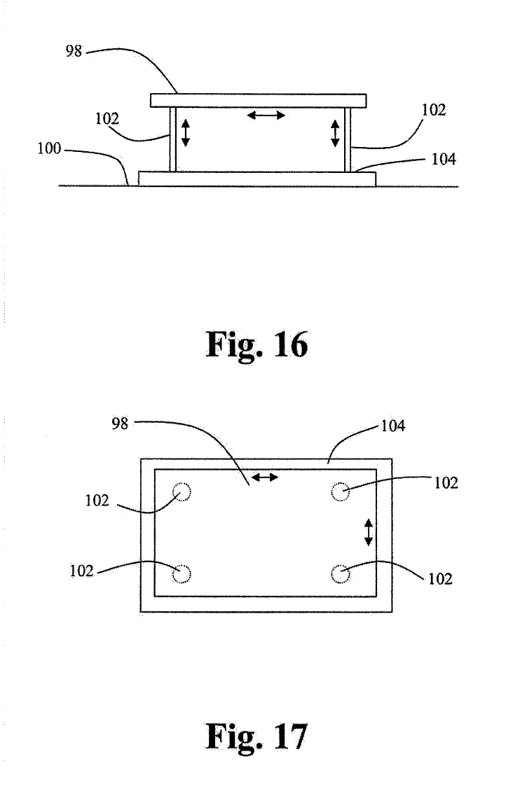

FIGS. 16 and 17 are schematic illustrations of a movable image sensor.

The basic Scheimpflug principle utilized in the present invention is explained using a view-camera type. The present invention may also be utilized in cameras of other types.

FIG. 1 is a schematic illustration of a basic view camera 10 having a rear standard 12 holding an image sensor. In the original type of view cameras the read standard 12 is a frame which holds a ground glass, used for focusing and composing the image before exposure. The ground glass is replaced by a holder having the light-sensitive film, plate, or image sensor for exposure.

The view camera 10 also comprises a front end 14 holding a lens 16. The front 14 and rear 12 standards may move in various ways relative to each other, unlike most other types of camera, giving control over focus, depth of field and perspective.

A bellows 18 forms a light-tight seal between the two ends 12 and 14. The bellows 18 is a flexible, accordion-like pleated box and has the ability to flex to accommodate the movements of the two standards 12 and 14.

The view camera 10 is attached to or mounted on a support 20. The support is usually in the form of a tripod.

As indicated by the arrows at 22 the front standard 14 is able to be moved in all directions. The front end or standard 14 is moved relative to the rear standard or end 12.

For detecting and/or registering the position of the front end 14 relative to the rear end 12 a sensor is provided, not illustrated here. The sensor provides an electrical signal representing the position of the front end 14 relative to the rear end 12.

FIG. 2 is a schematic illustration of the view camera 10 in a first position, where the front end 14 is pivoted around the point 24. This movement is called tilt.

The axis of the lens 16 is normally perpendicular to the plane of the film in the rear standard 12. Changing the angle between axis and film by tilting the lens 16 standard 14 backwards or forwards is called lens tilt or simply tilt. Tilt is especially useful in landscape photography. By using the Scheimpflug principle, the plane of focus may be changed so that any plane can be brought into focus. When the film plane and lens plane are parallel, as is the case for most 35 mm cameras, the plane of focus will also be parallel to these two planes. If, however, the lens plane is tilted with respect to the film plane, the plane of sharp focus will also be tilted according to geometrical and optical properties. This is illustrated and explained with reference to FIG. 5 below. The three planes will intersect in a line below the camera for downward lens tilt. The tilted plane of focus is very useful in that this plane may be made to coincide with a near and far object. Thus, both near and far objects on the plane will be in focus.

FIG. 3 is a schematic illustration of the view camera 10 in a second position, where the front end 14 is rotated around an axis parallel to the plane of the rear end 12. The view camera 10 is shown from above, as compared to the side-views of FIGS. 1, 2 and 4.

Altering the angle of the lens standard 14 in relation to the rear standard 12 plane by swiveling it from side to side is called swing. Swing is similar to tilt, but in the horizontal axis. Swing may be used to achieve sharp focus along the entire length of a picket fence, for example

FIG. 4 is a schematic illustration of the view camera 10 seen from the side in a third position, where the front end 14 is raised relative to the rear end 12. Vertical movement of the front end 14 in the plane parallel to the plane of the rear end 12 is sometimes referred to as rise and fall and sideways movement is sometimes referred to as shift. In the present specification the term shift is used to describe any movement of the front end 14 relative to the rear end 12 in a plane parallel to the plane of the rear end 12. In FIG. 3 only vertical movement is seen as the view camera is seen from the side.

Shift is a very important movement especially in architectural photography.

Generally, the lens is moved vertically, i.e. either up or down, along the plane parallel to the rear end 12 in order to change the portion of the image that will be captured on the film or image sensor.

The main effect of vertical shift is to eliminate converging parallels when photographing tall buildings. If a camera without movements is pointed at a tall building, the top will be cut off; if the camera is tilted upwards to get it all in, the film plane will not be parallel to the building, and the building will seem narrower at the top than the bottom; lines which are parallel in the object will converge in the image. To avoid this apparent distortion, a wide-angle lens will get more of the building in, but will include more of the foreground and alter the perspective. A camera with vertical shift front allows a lens to be raised to include the top of the building without tilting the camera.

FIG. 5 is a schematic illustration of the Scheimpflug principle. A lens element 36 is tilted relative to an image plane 46. The image plane is illustrated by the punctured line 46. A lens plane is illustrated by the punctured line 38. The image plane 46 and the lens plane intersect at 48. An object 40 is located in the object plane illustrated by the punctured line 42.

The object 40 is in focus. The object 40 is imaged onto the image plane 46 as illustrated by the line 44. This allows an object to be in focus over a distance that is not parallel to the image plane 46. The point 48 is called the Scheimpflug intersection point.

FIG. 6 is an image illustrating how focus using a traditional camera without the possibility to tilt the lens relative to the image plane looks like. A close-up photograph of a piece of paper is shown. The paper defines a plane that is tilted relative to the image plane in the camera. The lens of the camera defines a lens plane that is parallel to the image plane. The photo has three sections where the sections at 50 and 52 are out of focus and only the area at 54 is in focus. This may in some situations be acceptable, and in other situations something that needs to be avoided. The adaptor and camera described in the present specification provides the means for obtaining an image where the page shown in FIG. 6 would be focused throughout the image.

FIG. 7 is a side-view of an adaptor 56 allowing use of ordinary lenses and cameras to perform tilt and shift operations similar to those discussed above. The adaptor 56 include a lens mounting 58 allowing the adaptor 56 to be mounted on a camera body, as will be shown later. At the side opposite the lens mount 58 a lens mount 60 for receiving and holding a lens is placed.

The adaptor 56 comprises two parts 62 and 64. At the part 62 the lens mount 58 is positioned. At the part 64 the lens mount 60 is positioned. The part 64 is movable relative to the part 62. When the adaptor 56 is mounted on a camera body the part 62, and the lens mount 58 is parallel to the image plane in the camera body. A lens mounted at the lens mounting 60 may then be moved relative to the camera body via the adaptor 56 thereby providing tilt and shift functionality.

The adaptor 56 further comprises a magnifying device, not seen here, for enlarging or magnifying the light spot from a lens. When a lens is moved, i.e. tilted and/or shifted, the light coming from the lens hits or intersects an image recording medium differently from when the lens is positioned without tilt and/or shift. Therefore the light spot from the lens is enlarged. Images could be recorded without the enlargement, but it is advantageous that the spot is enlarged, as it is contemplated to provide better images compared to adaptors not having an enlargement device. The enlargement or magnifying device may also be a separate component coupled to the adaptor. In the embodiment shown in FIGS. 7-9 and 12-15 the enlargement is 1,5 times.

The adaptor 56 comprises a first knob or wheel 66. The wheel 66 allows a photographer to shift the part 64 of the adaptor 56 upwards relative to the part 62. When the wheel 66 is turned a toothed wheel engages a rack or cog railway 68. The rack or cog railway 68 is straight as illustrated. This provides shift in directions parallel to the image plane of a camera that the adaptor 56 is connected to or mounted on.

The adaptor 56 comprises a second knob or wheel 70. The wheel 70 allows a photographer to tilt the part 64 of the adaptor 56 relative to the part 62. When the wheel 70 is turned a toothed wheel engages a rack or cog railway 72. The rack or cog railway 72 is curved as illustrated. This provides tilt relative to the image plane of a camera that the adaptor 56 is connected to or mounted on.

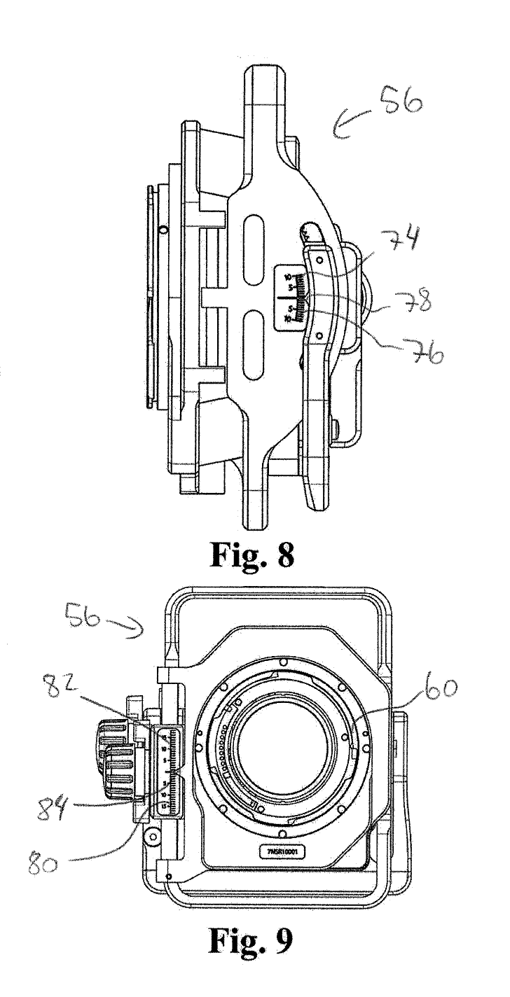

FIG. 8 is a schematic side-view of the adaptor 56 also shown in FIG. 7. In FIG. 8 the adaptor 56 is seen from the side opposite the side shown in FIG. 7.

The adaptor 56 comprises a visual indicator 74. The visual indicator 74 provides an indication to a photographer how much and in which direction the adaptor 56 is shifted. The visual indicator 74 comprises a scale 76 and a protruding part 78 used to visually indicate a position on the scale 76.

FIG. 9 is a schematic illustration of the adaptor 56 seen in a front view. The adaptor 56 comprises a visual indicator 80. The visual indicator 80 provides an indication to a photographer how much and in which direction the adaptor 56 is tilted. The visual indicator 80 comprises a scale 82 and a protruding part 84 used to visually indicate a position on the scale 82.

Also seen in FIG. 9 is the lens mount 60. The lens mount 60 is adapted or configured to receive a lens. The lens mount 60 have electrical contacts for transmitting electrical signals between the lens and a camera body. This allows the camera to control e.g. focus of the lens.

FIG. 10 is a schematic side-view of a camera body 86 connected to a lens 88 via an adaptor 56. The adaptor 56 is similar to the adaptor shown in FIGS. 7-9. The adaptor 56 is in this figure not tilted or shifted. The lens 88 is in an initial or zero-position.

FIG. 11 is a schematic side-view of the same assembly as illustrated in FIG. 10. Here the lens 88 is shifted downward relative to the zero-position shown in FIG. 10.

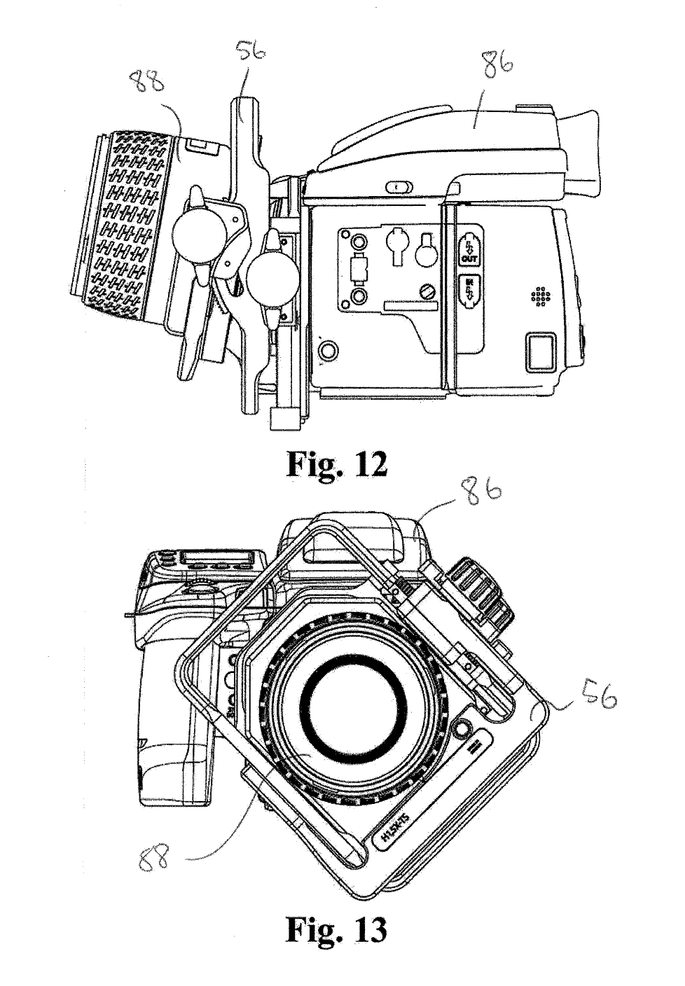

FIG. 12 is a schematic side-view of the same assembly as illustrated in FIGS. 10 and 11. Here the lens 88 is shifted upward relative to the camera body 86 and also tilted.

FIG. 13 is a schematic front view of the same assembly as illustrated in FIGS. 10-12. Here the lens 88 is rotated 45 degrees.

The three directions of movement, i.e. tilt, shift and rotation, may be combined by a photographer to achieve a desired positioning of the object plane.

In an advantageous embodiment of the present invention the photographer sets a desired focus and then manipulates the lens using the adaptor or camera according to the present invention. The adaptor includes sensors for registering the position of the adaptor, and thus also the lens. When the photographer has set a desired focus he or she may operate the camera to maintain that focus. The camera then registers the focus setting of the lens and the position of the lens relative to the camera. After the photographer changes the orientation of the lens, the camera may then calculate how to set the focus to maintain the same focus point as before.

FIG. 14 is a schematic view showing a sensor 86 comprising a block 88 and a registering device 90. In the embodiment shown in FIGS. 14 and 15 the sensor is a magnetic sensor. Other types of sensors may be implemented. Alternative types include resistive sensors, e.g. use of variable resistivity to indicate the position, optical sensors, capacitive sensors, or combinations thereof.

In FIG. 14 a wheel or handle 92 is shown. The wheel 92 turns the lens 94 via a gear 96. The sensor is also connected to the gear. The lens 94 is shown in a zero position, i.e. not manipulated or tilted.

FIG. 15 schematically shows the same device as in FIG. 14. Here the lens 94 has been tilted and the sensor 86 has registered the new position.

One reason to be interested in knowing the position of a lens relative to an image plane in a camera is that in digital cameras pixel vignetting may be a problem. Pixel vignetting is caused by angle-dependence of the digital sensors, i.e. CMOS or CCD sensor. Light incident on the sensor at a right angle produces a stronger signal than light hitting it at an oblique angle. The image recorded by the sensor may also be affected by light of different wavelength hitting the sensor in oblique angles. The sensors are usually designed to be lighted by a lens optical axis perpendicular to the plane of the sensor, i.e. the image plane of the camera. The angle-dependence of the digital sensor is not the same for every frequency. Surprisingly it has been found that the information from the sensor may improve and/or speed up image processing.

Knowing how the lens is orientated relative to the digital image sensor in a camera allows image processing software, either in the camera or in post production, to correct the image accordingly. This is contemplated to allow compensation of color degradation over the image or the like. Other types of compensation include distortion or aberration in the image.

The above is contemplated to allow performing correction of digital images comprising the steps of obtaining a digital image using a digital camera having digital image sensor in a camera housing, an image plane defined in the housing at the digital image sensor, the digital camera further comprising a lens, the lens configured to be movable relative to the housing, and a sensor configured to detect the position of the lens relative to the housing, the sensor configured to transmit position information in electronic form to a processor, and performing image correction using position data from the sensor.

Other advantageous embodiments of the present invention includes an embodiment where the sensor detect position of the second plane relative to the first plane by detecting distance to a point on the second plane. In a presently preferred embodiment the sensor may detect an amount of movement, e.g. by detecting turns on a wheel, sprocket or the like.

In a further advantageous embodiment the sensor may be a magnetic sensor, a resistive sensor, an optical sensor, a capacitive sensor or the like.

Additionally or in combination therewith the sensor may be connected to camera and sensor data may be recorded with image data in the camera.

Still further position data may be stored in a memory device positioned within or connected to the camera. The memory device may be a volatile memory device or in the alternative a non-volatile memory device. Examples include flash memory, hard drives, RAM devices, DPRAM devices, optical drives or any other type of memory device or combination of memory devices.

In a further embodiment of the present invention position data may stored as meta-data in the image file. The image files may be stored in a variety of formats. Examples include file types such as JPG, JPEG, Exif, JFIF, TIFF or Raw image format. In some embodiments multiple files are stored for each image captured by the digital image sensor, e.g. a JPEG image file and a RAW image file.

Even further advantageously an image processor is configured to perform correction of an image based on information received from the sensor or sensors, the correction including vignetting, distortion, aberration or a combination thereof. The image processor may be positioned in the camera or in an external device where the image processor receives an image file and sensor data from the camera.

In an even further advantageous embodiment the device may comprise one or more sensors for detecting all degrees of freedom of the second plane relative to the first plane, including rotation, tilt, shift and/or swing.

In some embodiments the digital image sensor may be a CMOS or CCD device. The digital image sensor may have a 3:2, 4:3, 16:9 form or aspect ratio. Alternatively images from the image sensor may be processed to any form or aspect ratio. The form or aspect ratio is considered as a relation between two sides in a rectangular image.

Also the image correction may comprise correction for vignetting, distortion, aberration or a combination thereof.

Advantageously position data is obtained for three directions and used during the image correction. Additionally correction may be performed for a multitude of frequency intervals and a plurality of angles.

Further advantageously movement from one position of the lens to a different position is followed by using position data to calculate a new focus setting so that focus is maintained before an image is recorded.

FIG. 16 is a schematic view of a digital image sensor 98 seen from the side. The image sensor 98 is mounted on a surface 100 via movable legs or connectors 102. By changing the length of the legs or connectors 102 the image sensor 98 may be moved. The image sensor 98 may then perform movements similar to those described above. As indicated by the arrows the image sensor 98 may be moved in any direction, this may in some embodiments be achieved by piezo actuators. In advantageous embodiments piezo electrical actuators may be used. The distance between the image sensor 98 and the block 104 are not shown to scale.

FIG. 17 is a schematic view of the digital image sensor 98 of FIG. 16 seen from above. Four legs or connectors 102 hold or support the image sensor 98. The digital image sensor may be moved in the directions indicated by the arrows. The movements shown in FIGS. 16 and 17 of the image sensor may be combined in any way.

Sensors detecting the amount of movement of the legs or connectors 102 are included. The information may be sent or transmitted to be stored in or with image data, e.g. as meta data as described above. Also sensor or sensors detecting and/or registering the movement of the image sensor the parallel to the plane 100 is included. Data from this or these sensors may be stored similarly.

The above advantages and features may be combined and used in any of the aspects of the present invention.

The present invention may relate to the following points

1. A device comprising:

a frame having a first part defining a first plane and a second part defining a second plane, the first part configured to be mounted to a camera body and the second part configured to be mounted to a lens, the second part being movable relative to the first part, and

a sensor configured to detect the position of the second plane relative to the first plane, the sensor configured to transmit position information in electronic form to a processor.

2. A digital camera including a digital image sensor in a camera housing, an image plane defined in the housing at the digital image sensor, the digital camera further comprising a lens mount for receiving a lens, the lens configured to be movable relative to the housing, and

a sensor configured to detect the position of the lens relative to the housing, the sensor configured to transmit position information in electronic form to a processor.

3. A digital camera including a digital image sensor in a camera housing, the digital image sensor being movably mounted in the camera housing, an image plane defined in the housing by the digital image sensor, the digital camera further comprising a lens mount for receiving a lens, the lens mount fixing the lens to the camera housing, and

a sensor configured to detect the position of the digital image sensor relative to the housing, the sensor configured to transmit position information in electronic form to a processor.

4. The device or digital camera according to any of the points 1-3, wherein the sensor is a magnetic sensor, a resistive sensor, an optical sensor, a capacitive sensor or the like.

5. The device or digital camera according to any of the points 1-4, wherein the sensor connected to camera and sensor data is recorded with image data in the camera.

6. The device or digital camera according to any of the points 1-5, wherein position data is stored in a memory device positioned within or connected to the camera.

7. The device or digital camera according to any of the points 1-6, wherein data is stored as meta-data in the image file.

8. The device or digital camera according to any of the points 1-7, wherein an image processor is configured to perform correction of an image based on information received from the sensor or sensors, the correction including vignetting, distortion, aberration or a combination thereof.

9. The device or digital camera according to any of the points 1-8, wherein the device comprises one or more sensors for detecting all degrees of freedom of the second plane relative to the first plane, including rotation, tilt, shift and/or swing.

10. The device or digital camera according to any of the points 1-9, wherein the image sensor is a CMOS, CCD device or the like.

11. A method of performing correction of digital images comprising the steps of:

obtaining a digital image using a digital camera having digital image sensor in a camera housing, an image plane defined in the housing at the digital image sensor, the digital camera further comprising a lens, the lens configured to be movable relative to the housing, and a sensor configured to detect the position of the lens relative to the housing, the sensor configured to transmit position information in electronic form to a processor, and

performing image correction using position data from the sensor.

12. The method according to point 11, wherein the image correction comprises correction for vignetting, distortion, aberration or a combination thereof.

13. The method according to point 11 or 12, wherein position data is obtained and used during the image correction.

14. The method according to any of the points 11-13, wherein correction is performed for a multitude of frequency intervals and a plurality of angles.

15. The method according to any of the points 11-14, wherein the method comprises movement from one position of the lens to a different position is followed by using position data to calculate a new focus setting so that focus is maintained before an image is recorded.

1-17. (canceled)

18. A digital camera comprising:
a digital image sensor in a camera housing, an image plane defined in the housing at the digital image sensor, the digital camera further comprising a lens mount for receiving a lens, the lens configured to be movable relative to the housing; and
a sensor configured transmit a sensor signal transmit a sensor signal to a processor, the position of the lens relative to the housing being determined based on the sensor signal, the processor being configured to calculate an image correction parameter based on the position information, the image correction parameter being used for correcting optical errors in a recorded image due to the position of the lens relative to the image plane, the optical errors including vignetting, distortion, aberration or a combination thereof.

19. A digital camera according to claim 18, wherein the sensor is a magnetic sensor, a resistive sensor, an optical sensor, a capacitive sensor or the like.

20. A digital camera according to claim 18, wherein the sensor data is recorded with image data in the camera.

21. A digital camera according to claim 18, wherein position data is stored in a memory device positioned within or connected to the camera.

22. A digital camera according to claim 18, wherein data is stored as meta- data in the image file.

23. A digital camera according to claim 18, wherein the image processor configured to perform correction of an image based on information received from the sensor or sensors is a processor in a device remote from the camera.

24. A digital camera according to claim 18, wherein the device comprises one or more sensors for detecting all degrees of freedom of the second plane relative to the first plane, including rotation, tilt, shift and/or swing.

25. A digital camera according to claim 18, wherein the image sensor is a CMOS, CCD device or the like.

26. A digital camera comprising:
a digital image sensor in a camera housing, the digital image sensor being movably mounted in the camera housing, an image plane defined in the housing by the digital image sensor, the digital camera further comprising a lens mount for receiving a lens, the lens mount fixing the lens to the camera housing; and
a sensor configured transmit a sensor signal transmit a sensor signal to a processor, the position of the digital image sensor relative to the housing being determined based on the sensor signal, the processor being configured to calculate an image correction parameter based on the position information, the image correction parameter being used for correcting optical errors in a recorded image due to the position of the lens relative to the image plane, the optical errors including vignetting, distortion, aberration or a combination thereof

27. A digital camera according to claim 26, wherein the sensor is a magnetic sensor, a resistive sensor, an optical sensor, a capacitive sensor or the like.

28. A digital camera according to claim 26, wherein the sensor data is recorded with image data in the camera.

29. A digital camera according to claim 26, wherein position data is stored in a memory device positioned within or connected to the camera.

30. A digital camera according to claim 26, wherein data is stored as meta-data in the image file.

31. A digital camera according to claim 26, wherein the image processor configured to perform correction of an image based on information received from the sensor or sensors is a processor in a device remote from the camera.

32. A digital camera according to claim 26, wherein the device comprises one or more sensors for detecting all degrees of freedom of the second plane relative to the first plane, including rotation, tilt, shift and/or swing.

33. A digital camera according to claim 26, wherein the image sensor is a CMOS, CCD device or the like.

34. A digital camera comprising:
a digital image sensor in a camera housing, an image plane defined in the housing at the digital image sensor, the digital camera further comprising a lens mount for receiving a lens, the lens configured to be movable relative to the housing; and
a sensor configured transmit a sensor signal to a processor, the position of the lens relative to the housing being determined based on the sensor signal, a correction parameter calculated based on the sensor signal, the correction parameter being used for correcting focal settings while the lens is moved relative to the image plane.

35. A digital camera according to claim 34, wherein the lens is refocused continuously during the period where the lens is moved relative to the image plane.

36. A digital camera according to claim 34, wherein the sensor is a magnetic sensor, a resistive sensor, an optical sensor, a capacitive sensor or the like.

37. A digital camera according to claim 34, wherein the sensor data is recorded with image data in the camera.

38. A digital camera according to claim 34, wherein position data is stored in a memory device positioned within or connected to the camera.

39. A digital camera according to claim 34, wherein data is stored as meta-data in the image file.

40. A digital camera according to claim 34, wherein the image processor configured to perform correction of an image based on information received from the sensor or sensors is a processor in a device remote from the camera.

41. A digital camera according to claim 34, wherein the device comprises one or more sensors for detecting all degrees of freedom of the second plane relative to the first plane, including rotation, tilt, shift and/or swing.

42. A digital camera according to claim 34, wherein the image sensor is a CMOS, CCD device or the like.

43. A method of performing correction of digital images, comprising:
obtaining a digital image using a digital camera having digital image sensor in a camera housing, an image plane defined in the housing at the digital image sensor, the digital camera further comprising a lens, the lens configured to be movable relative to the housing, and a sensor configured to detect the position of the lens relative to the housing, the sensor configured to transmit position information in electronic form to a processor; and
performing image correction using position data from the sensor.

44. A method according to claim 43, wherein the image correction comprises correction for vignetting, distortion, aberration or a combination thereof.

45. A method according to claim 43, wherein position data is obtained and used during the image correction.

46. A method according to claims 43, wherein correction is performed for a multitude of frequency intervals and a plurality of angles.

47. A method according to claims 43, wherein the method comprises movement from one position of the lens to a different position is followed by using position data to calculate a new focus setting so that focus is maintained before an image is recorded.
